(19) United States
(12) Patent Application Publication
(10) Pub. No.: US 2006/0194496 A1
(43) Pub. Date: Aug. 31, 2006

(54) Nonwoven laminate structure

(75) Inventors: John J. Burns, Simpsonville, SC (US); Smita P. Edmonds, Greer, SC (US); Jerry W. Owens JR., Boiling Springs, SC (US)

Correspondence Address: James M. Robertson;J.M. Robertson Intellectual Property, LLC, First Floor, 233 S. Pine Street, Spartanburg, SC, 29302, US

(73) Assignee: THE FELTERS COMPANY

(21) Appl. No.: 11/412,495

(22) Filed: Apr. 27, 2006

Related U.S. Application Data
(62) Division of application No. 09/576,720, filed on May 23, 2000.

(51) Int. Cl. B32B 5/26; B32B 5/06

(52) U.S. Cl. 442/381; 442/387; 442/268

(57) ABSTRACT

A nonwoven composite structure having a plurality of layers of nonwoven fiber batting bonded in laminating relation to one another by a localized adhesive disposed between the layers. The adhesive between the layers of fiber batting preferably extends across the interface between the adjacent layers so as to at least partially penetrate each of the layers thereby enhancing the bond strength between the layers. The bond strength between the layers and the uniformity of the resultant bonded structure may be further enhanced by forcibly extending fibers from at least one layer of batting through the material forming the adhesive such as by needling prior to activation of the adhesive such that a portion of the fibers forming the layers of batting extends across the adhesive between the bonded layers.

### TECHNICAL FIELD

The present invention relates to nonwoven structures, and more particularly to a structure of laminate construction having multiple layers of nonwoven material in overlying adhesive bonded relationship to one another. In addition, the structure may also be characterized by a relatively high thickness and density. A method for forming such a structure is also provided.

### BACKGROUND OF THE INVENTION

It is well known to form nonwoven structures through the needle punching of staple fibers. In such an operation, a plurality of barbed needles are passed through a collection of such fibers in a repeating fashion so as to result in the intimate entanglement of such fibers with one another. As the level of entanglement is increased, the individual fibers are formed into a cohesive fiber batt. Continued needling of the fiber batt tends to increase the density and structural integrity thereof due to increasing levels of entanglement between the individual component fibers.

In some applications it is desirable to use nonwoven structures of relatively substantial thickness due to the performance characteristics associated with such materials. Those performance characteristics may include enhanced structural integrity, abrasion resistance, rigidity and/or noise dampening properties. However, the production of such high thickness materials may require the use of specialized and/or dedicated equipment thereby increasing the cost of production.

In some applications such as metal wiping or polishing operations, it may further be desirable for the structure to be characterized by a combination of substantial thickness and density so as to prolong the useful life of the article. However, the production of articles exhibiting characteristics of both substantial thickness and high density has been generally difficult to achieve in an efficient manner using standard needling equipment and practices due to the substantial number of needle passes required to produce such a product.

It would be desirable to have a highly efficient and cost effective method of producing nonwoven structures of relatively substantial thickness using standard needling equipment. In particular, it would be desirable to have a method to produce nonwoven structures of virtually any desired thickness without regard to needle length and needling equipment limitations.

The difficulties associated with the production of high thickness nonwoven structures are further compounded in the production of higher density products. In particular, it has been found that in order to obtain higher density materials, the product must undergo a substantially increased level of needling which tends to increase manufacturing cost. In addition, as the thickness of the article is increased, the resistance encountered by the needles is likewise increased thereby tending to damage or dislodge the individual needles used in the operation. Furthermore, even if the needles are not damaged or dislodged, the product which can be produced is nonetheless limited in thickness by the finite length of the needles which are used.

### SUMMARY OF THE INVENTION

The present invention provides advantages and alternatives over the prior art by providing a nonwoven structure of virtually any desired thickness which may be produced in a highly efficient and cost effective manner. The present invention utilizes a laminate construction wherein individually formed lengths of fiber batting such as air laid or needle punched batting are adhesively bonded to one another by intermediate layers of adhesive to achieve a composite laminate structure of desired thickness. The adhesive bonding is preferably achieved through utilization of an adhesive disposed in localized fashion between the layers of fiber batting which may otherwise be substantially free of any adhesive constituent. The adhesive may be activated within a heated press or calender thereby bonding the individual layers of fiber batting together. The adhesive may be in the form of an activatable sheet material or fabric which may be lightly secured in place between layers of fiber batting through use of a needling operation preceding adhesive bonding such that there is a combination of mechanical and adhesive bonding between adjacent layers of fiber batting. Other adhesives such as liquid adhesives may also be utilized. The structure may be built to any desired thickness through the addition of layers of fiber batting material.

The present invention provides yet further advantages and alternatives over the prior art by providing a nonwoven structure characterized by both substantial thickness and enhanced density which may be produced in a highly efficient and cost effective manner. The present invention utilizes a laminate construction wherein individually formed lengths of enhanced density fiber batting of thickness as may be formed on standard needle looms are adhesively bonded to one another to achieve a composite laminate structure of virtually any desired thickness. The adhesive bonding is preferably achieved through utilization of an adhesive disposed in localized fashion between the layers of fiber batting which may otherwise be substantially free of any adhesive component. The adhesive may be activated within a heated press or calender thereby bonding the individual layers of fiber batting together and further increasing the density of the structure. The resultant structure of high density material may be built to any desired thickness through the addition of further layers.

According to one potentially preferred aspect of the present invention, these advantages and features may be accomplished by providing a structure having a plurality of layers of nonwoven fiber batting bonded in laminating relation to one another by a localized adhesive disposed between the layers. The adhesive between the layers of fiber batting preferably extends across the interface between the adjacent layers so as to at least partially penetrate each of the layers thereby enhancing the bond strength between the layers. The bond strength between the layers and the uniformity of the resultant bonded structure may be further enhanced by forcibly intermingling the fibers from at least one layer of batting with the material forming the adhesive such as by needling prior to activation of the adhesive such that a portion of the fibers forming the layers of batting extends across the adhesive between the bonded layers thereby giving rise to both mechanical and adhesive bonding between the individual layers of batting.

In accordance with another potentially preferred aspect of the present invention, the structure may be characterized by a thickness of about 6.35 mm or greater.

In accordance with still another potentially preferred aspect of the present invention, the structure may be characterized by a density in the range of about 0.10 to about 0.55 grams per cubic centimeter.

In accordance with yet another potentially preferred aspect of the invention, the structure may be formed from individual fiber batting layers which are either similar or dissimilar in terms of construction and/or fiber composition.

In accordance with yet another potentially preferred aspect of the invention, the structure may be formed using multiple adhesive layers which are either similar or dissimilar from one another.

According to yet a further potentially preferred aspect of the invention, the adhesive utilized to bond the layers of nonwoven fiber batting together may be either a liquid or dry adhesive. Such dry adhesives may be in the form of an activatable solid such as a film or fabric-like web.

In accordance with still a further aspect of the present invention, the adhesive utilized to bond the layers of nonwoven fiber batting together may be activated in selected areas such that the bonding between the layers is in a pattern.

### BRIEF DESCRIPTION OF THE DRAWINGS

The present invention will now be described, by way of example only, with reference to the accompanying drawings, in which:

FIG. 1. illustrates an embodiment of a nonwoven structure according to the present invention.

FIG. 2 is a flow diagram of the steps performed in a potentially preferred process for formation of a nonwoven structure according to the present invention;

FIG. 3 illustrates the formation of a preliminary fiber batt for subsequent processing according to the potentially preferred process of the present invention;

FIG. 4 illustrates the needling of a plurality of fiber batts as formed in FIG. 3 so as to combine such batts into an enhanced density batting material;

FIG. 5 illustrates the formation of a sandwich structure of adhesive between layers of enhanced density batting material as formed in FIG. 4; and

FIG. 6 illustrates the delivery of a sandwich structure as may be formed in FIG. 5 to a press or calender unit for activation of the adhesive within the sandwich structure.

While the invention has been illustrated and generally described above and will hereinafter be described in detail in connection with certain potentially preferred embodiments and practices, it is to be understood that both the foregoing general description as well as the illustrated embodiments and practices and corresponding detailed description are exemplary and explanatory only and are not to be construed as restrictive of the invention in any way. On the contrary, it is intended that the present invention shall extend to all alternatives, modifications and equivalents as may embrace the principles of this invention within the true spirit and scope thereof.

### DESCRIPTION OF THE PREFERRED EMBODIMENT

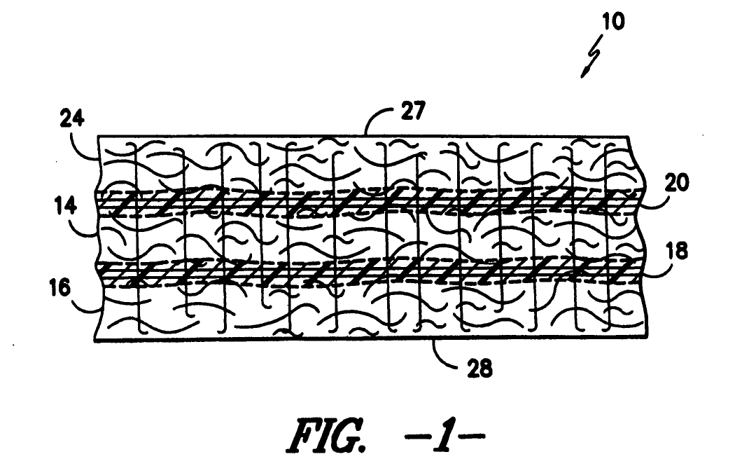

Referring now to the drawings, in FIG. 1, there is shown a cross section of a nonwoven structure 10 according to the present invention. The nonwoven structure 10 is contemplated to be useful in a number of applications as may require relatively substantial thickness in either low or high density constructions. One such application which is particularly contemplated is the wiping or polishing of metal articles (now shown) such as steel rolls and the like. As will be appreciated, such polishing operations may require the nonwoven structure 10 to have sufficient fiber density to avoid undue degradation during the wiping or polishing operation. Moreover, it may be desirable for the nonwoven structure 10 to have a sufficient thickness to avoid the need for repair or replacement on a frequent basis.

As illustrated, the nonwoven structure 10 preferably includes a first layer 14 of a nonwoven fiber batting adhesively bonded to a second layer 16 of nonwoven fiber batting by an adhesive 18 in a manner to be discussed further hereinafter. It is to be understood that for illustrative purposes, the relative thickness of the adhesive layers within the nonwoven structure 10 is greatly enlarged, whereas in the potentially preferred embodiment, the adhesive will preferably occupy a relatively thin cross section within the nonwoven structure 10 thereby being substantially unnoticeable and giving the appearance of a single continuous layer. According to the illustrated and potentially preferred embodiment, the nonwoven structure 10 may further include at least a third layer of nonwoven fiber batting 24 bonded in laminated relation to the first layer 14 of nonwoven fiber batting by a layer of adhesive 20 thereby forming a structure 10 having three layers of nonwoven fiber batting 14, 16, 24 and two layers of adhesive 18, 20.

While the nonwoven structure 10 as illustrated in FIG. 1, may be potentially preferred for some applications, it is contemplated that a greater or fewer number of layers of nonwoven fiber batting may likewise be incorporated as desired. Thus, by way of example only, it is contemplated that one or more additional layers (not shown) of nonwoven fiber batting may be bonded to the outer surfaces 27, 28 of the illustrated nonwoven structure 10 by additional layers of adhesive so as to form a composite structure of any thickness as may be desired. It is likewise contemplated that one or more layers of material other than nonwoven fiber batting such as woven, knit, stitched, or thermal bonded material may also be incorporated into the laminate in substitution for one or more layers of fiber batting to thereby derive the aesthetic and/or functional characteristics of such material.

According to the illustrated and potentially preferred embodiment of the present invention, the layers 14, 16, 24 of the nonwoven structure 10 are preferably formed from a plurality of staple fibers which have been joined into a substantially cohesive and stable structure by needling operations as are well known to those of skill in the art. It is contemplated that the staple fibers which make up the layers 14, 16, 24 of nonwoven fiber batting may be of any type suitable for entanglement. By way of example only, and not limitation, such fibers may include polyester fibers, wool fibers, polypropylene fibers, acrylic fibers, NOMEX® fibers, acetate fibers, aramid fibers, rayon fibers, and blends thereof. Fibers characterized by a linear density in the range of about 2 denier to about 15 denier having an average staple length in the range of about 50 mm to about 105 mm may be preferred. Polyester fibers may be particularly preferred. It is contemplated that the layers 14, 16, 24 need not include any internal adhesive constituent due to the bonding provided by the individual layers of adhesive 18, 20, although such a constituent may be included if desired.

While in many instances it may be desirable that each of the layers 14, 16, 24 of nonwoven fiber batting be substantially similar in character and composition to one another, it is likewise contemplated within the scope of the present invention that such layers may be dissimilar in terms of chemical composition of the materials forming such layers and/or in terms of the physical character of such layers. As will be appreciated, in the event that the third layer 24 of nonwoven fiber batting is dissimilar to the second layer 16 of nonwoven fiber batting, the outer surfaces 27, 28 of the nonwoven structure 10 will have differing character and consequently different performance characteristics which may be desired in some applications.

While the layers of adhesive 18, 20 may be substantially similar to one another, it is contemplated that the layers of adhesive 18, 20 may also differ from one another in physical and/or chemical character including melting point or chemical resistance such that the performance of such layers will differ across the final nonwoven structure 10. By way of example only, it is contemplated that the material forming the adhesive layers may differ in the event that the layers of nonwoven fiber batting are dissimilar in different regions of the structure 10.

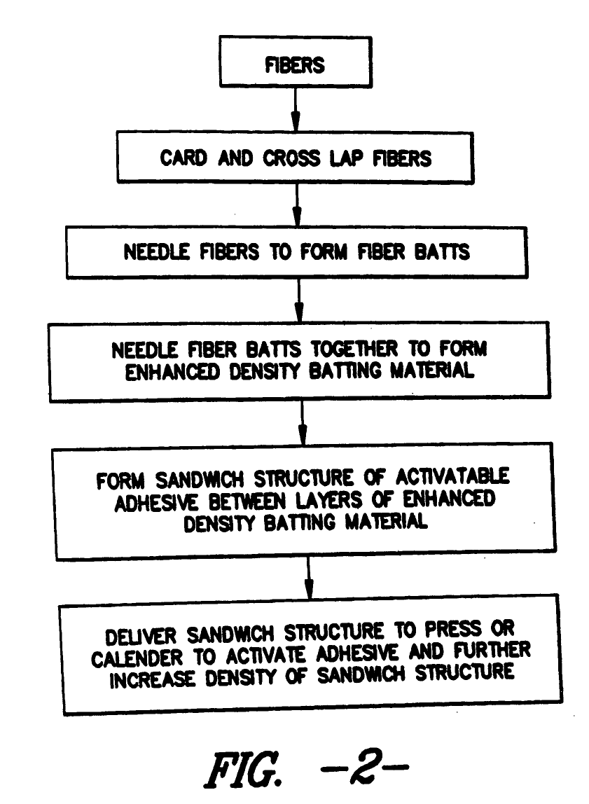

FIGS. 2-6 illustrate one potentially preferred process for forming the nonwoven structure 10 according to the present invention which is characterized by both substantial thickness and density. As illustrated, according to such potentially preferred process, nonwoven staple fibers 30 which have undergone traditional carding and cross lapping are conveyed from a cross lapper 32 to a batt-forming needle loom 34. As the fibers 30 are conveyed through the batt-forming needle loom 34, the needles thereof are reciprocated through the cross lapped fibers so as to enhance the entanglement thereof and to thereby produce a roll of fiber batting material 38 which may be taken up on an A-frame or other support device 40. Such fiber batting material will preferably have a thickness in the range of about 2 mm to about 10 mm with a density in the range of about 0.065 to about 0.075 grams per cubic centimeter and will most preferably have a thickness of about 5.2 mm with a density of about 0.072 grams per cubic centimeter.

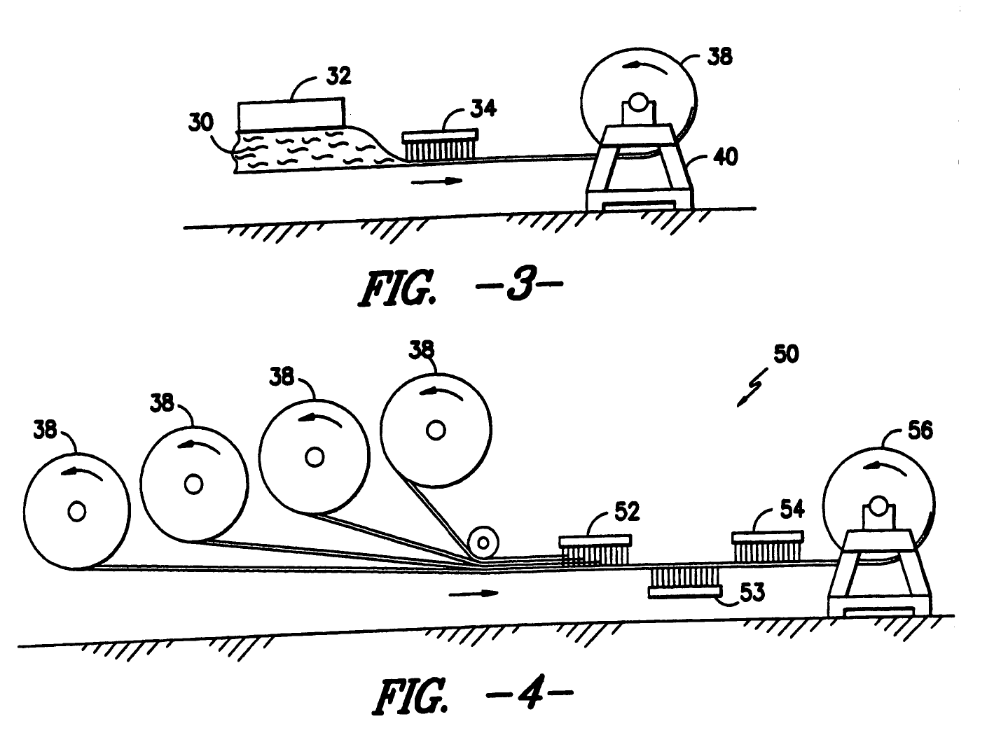

As illustrated in FIG. 4, following the formation of the rolls of fiber batting material 38, according to the potentially preferred practice of the present invention a plurality of such rolls of fiber batting material 38 may thereafter be conveyed to a combining and densification station 50. At the combining and densification station 50, the batting material 38 is conveyed in layered orientation to a combining needle loom 52 which serves to substantially connect the layers of fiber batting material 38 together. The resultant combined material is thereafter transported through densifying needle looms, 53, 54 which are preferably arranged in series with the combining needle loom 52 as shown. The resultant product is an enhanced density batting material 56 which preferably has a thickness in the range of about 3 mm to about 19 mm with a density in the range of about 0.1 to about 0.4 grams per cubic centimeter and will most preferably have a thickness of about 5.7 mm with a density of about 0.24 grams per cubic centimeter.

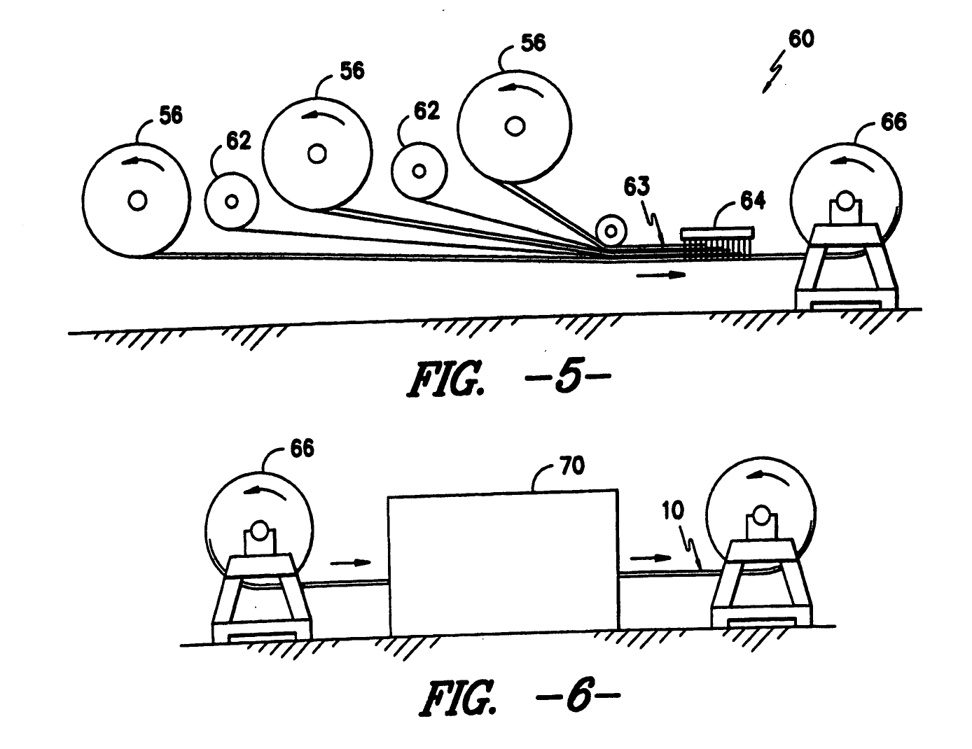

According to the potentially preferred practice of the present invention, following formation of the enhanced density batting material 56, a plurality of such rolls of enhanced density batting material 56 are thereafter conveyed to a laminate formation station 60 as illustrated in FIG. 5. At the laminate formation station 60 the enhanced density batting material 56 is preferably conveyed in overlying and underlying relation to intermediate layers of adhesive material 62 thereby forming a sandwich structure 66 in which the adhesive material 62 is disposed between the layers of enhanced density batting material 56. While the formation of a sandwich structure 66 incorporating only three layers of enhanced density batting material 56 is illustrated thereby corresponding substantially to the illustrated nonwoven structure 10 in FIG. 1, it is to be understood that a larger number of layers of enhanced density batting material 56 may likewise be formed into a sandwich structure 66 with intermediate layers of adhesive material 62 between such layers if desired. It is likewise contemplated that materials other than batting material such as woven, knit, stitched, or thermal bonded material may be substituted for one or more of the rolls of enhanced density batting material 56 during formation of the sandwich structure 66 so as to derive the properties of such materials.

According to the potentially preferred practice, the resultant layered sandwich structure 66 is thereafter conveyed through an entangling needle loom 64 which serves to mechanically intermingle a portion of the fibers from one or more layers of enhanced density batting material 56 with the adhesive material 62 and with the adjacent layer of batting or other material as may be incorporated within the sandwich structure 66 thereby mechanically binding the layers of the sandwich structure 66 together and increasing overall strength. Such a mechanical joining operation preferably results in a portion of the fibers 30 extending substantially across the thickness of the layered sandwich structure 66 and thus through multiple layers of the nonwoven article 10 formed therefrom as best seen in FIG. 1.

While the adhesive material may be any wet or dry adhesive as may be suitable to bind the adjacent layers of nonwoven material together, it is contemplated that the adhesive material 62 will preferably be a dry adhesive in web form such as a film or generally scrim-like fabric construction so as to promote the ease of use of the adhesive in roll form and to further permit the relatively easy mechanical intermingling to be carried out by the entangling needle loom 64. The adhesive material is preferably of a nature such that it can be activated upon demand through the application of a predetermined driving force such as heat, hot gas, chemical interaction, ultrasonic energy, radio frequency radiation waves and the like. The adhesive utilized will also preferably not substantially alter the physical character of nonwoven batting material in features such as filtration, fluid retention and fluid transfer. Further, it is contemplated that the adhesive should provide necessary resistance to heat, humidity and chemical interaction so as to avoid any premature delamination. In particular, it is contemplated that the adhesives utilized should be useful over a wide range of temperatures from about minus 30 degrees Celsius to about 180 degrees Celsius. One such heat activated adhesive which may be particularly preferred is a spunbond adhesive fabric believed to be available under the trade designation SPUNFAB® adhesive fabric from Dry Adhesive Technologies Inc. having a place of business at Cuyahoga Falls, Ohio, USA. According to the potentially most preferred embodiment, the adhesive is the SPUNFAB® type PA1001 polyamide adhesive fabric. However, other such adhesive fabrics of polyester, polyolefin, and ternary systems are also contemplated.

It is to be appreciated that in some instances the utilization of the entangling needle loom 64 to mechanically bond the adhesive material 62 between the layers of nonwoven fiber batting may be avoided if proper placement of the adhesive between the layers of nonwoven fiber batting is maintained. However, in the event that the entangling operation is carried out, the resultant sandwich structure which preferably incorporates three layers of nonwoven batting material 56 and two layers of adhesive material 62 will preferably have a density in the range of about 0.1 to about 0.4 grams per cubic centimeter and will most preferably have a density of about 0.27 grams per cubic centimeter.

While the resultant sandwich material 66 is illustrated as being collected in roll form, in any event that such sandwich material has a thickness greater than about 25 mm, it may be preferable to collect such material as a flat sheet for further processing.

According to the potentially preferred practice of the present invention wherein the adhesive material 62 is activated by heat, following the relative placement of the adhesive material 62 between the layers of batting material 56, the resultant sandwich material 66 is thereafter passed to a heated platen press or calender unit 70 as will be well known to those of skill in the art. Upon introduction to the heated platen press or calender unit 70, the sandwich material 66 is subjected to heat and pressure so as to activate the adhesive and further enhance the density of the batting material 56 as may be desired up to about 0.55 grams per cubic centimeter. Such activation results in the adhesive material 62 undergoing a phase transformation from solid to viscous fluid thereby permitting the adhesive material to flow into the overlying and underlying batting material 56 so as to form an adhesive bond between such materials. Within the press or calender unit 70, shims are preferably utilized at the edges of the sandwich material 66 so as to obtain a controlled degree of compression within the batting material 56. After cooling to stabilize the activated adhesive material 62, the felt structure 10 according to the present invention is obtained.

While bonding along the entire surface of the adjacent layers of batting material 56 may be desirable in many instances, it is also contemplated that activation may be selective so as to result in a discontinuous patterned bond such that some areas are left unbonded. By way of example only, it is contemplated that such a patterned bond may be effected in an efficient manner through use of directional bonding procedures including the application of radio frequency radiation or ultrasonic energy.

In the event that additional thickness is desired, it is contemplated that the composite which exits the press or calender unit 70 may be returned to the laminate formation station 60 for the application of additional layers of nonwoven batting 56 and intermediate adhesive material 62 so as to form an expanded sandwich material. If desired, a mechanical bonding operation may be performed at the entangling needle loom 64 to hold such additional layers of nonwoven batting 56 in place against the outer surface 27, 28 (FIG. 1) of the previously formed composite. The expanded sandwich material may thereafter be passed through the heated platen press or calender unit 70 for activation of the newly applied adhesive material. This procedure for the addition of material may thereafter be repeated until such time as a desired thickness is achieved.

It is contemplated that the lamination process according to the present invention may be useful in the formation of nonwoven structures 10 of virtually any thickness characterized by either a high or low density although it may be most useful in the production of nonwoven structures characterized by a thickness of greater than or equal to about 6.3 mm. In the event that a high density product is desired, the procedures as outlined above may be utilized. In the event that a lower density product is desired, the procedures which result in material densification may be substantially curtailed although the use of mechanical entanglement between adjacent layers may still be potentially preferred.

The procedures and features of the present invention may be further understood through reference to the following non limiting example:

### EXAMPLE

A felt structure was formed of 3 denier 76.2 mm polyester staple fiber by carding, cross lapping and needling the fiber to form preliminary fiber batts having a thickness of about 5.2 mm and a density of about 0.071 grams per cubic centimeter. Four of such preliminary fiber batts were thereafter combined and densified in a three stage needling loom thereby forming an enhanced density fiber batt having a thickness of about 5.7 mm and a density of about 0.238 grams per cubic centimeter. Three of such enhanced density fiber batts were thereafter passed through a single stage needling loom in sandwiching relation to two layers of a scrim fabric of meltable polyamide adhesive having an area density of about 27.1 grams per square meter thereby binding the scrim fabric between the fiber batts such that fibers from the fiber batts and the scrim fabric are mechanically entangled. The resulting sandwich structure had a thickness of about 15 mm and a density of about 0.27 grams per cubic centimeter. The sandwich structure was thereafter passed to a heated platen press where it was subjected to a pressure of 14.2 Kg per square cm at 155 degrees Celsius. Shims having a thickness of 14 mm were inserted on either side of the sandwich structure to limit compression. After cooling, the resultant product was measured to have a thickness of about 12.7 mm and a density of about 0.32 grams per cubic centimeter. The resultant product was useful as a pad for the wiping and polishing of metal articles.

1-21. (canceled)

22. A method for forming a nonwoven composite structure comprising the steps of:
(a) forming a plurality of individual layers of nonwoven fiber material by needle punching a plurality of fiber elements;
(b) placing discrete layers of adhesive between the layers of nonwoven fiber material; and
(c) activating said layers of adhesive thereby bonding said individual layers of nonwoven fiber material together in a laminate structure such that an adhesive layer extends between said individual layers of nonwoven fiber material.

23. The invention according to claim 1, wherein prior to the activating step, a first portion of the fiber elements forming one or more of said layers of nonwoven fiber material are forced through one or more of said layers of adhesive across substantially the entire composite structure such that mechanical entanglement is established between adjacent layers of nonwoven fiber material across substantially the entire interface between said adjacent layers.

24. A method for forming a nonwoven composite structure comprising the steps of:
(a) forming a plurality of individual layers of nonwoven fiber material by needle punching a plurality of fiber elements;
(b) placing discrete layers of heat activatable adhesive between the layers of nonwoven fiber material to form a multi-layer construction;
(c) needle punching the multi-layer construction such that a portion of the fiber elements forming one or more of said layers of nonwoven fiber material are forced through one or more of said layers of adhesive across substantially the entire composite structure such that mechanical entanglement is established between adjacent layers of nonwoven fiber material across substantially the entire interface between said adjacent layers and a portion of the fiber elements in each of said individual layers are forced into but not across a layer of adhesive between said individual layers;
(d) activating said discrete layers of adhesive under pressure thereby bonding said individual layers of nonwoven fiber material together in a laminate structure such that an adhesive layer extends between said individual layers of nonwoven fiber material.
